(19) United States
(12) Patent Application Publication
(10) Pub. No.: US 2006/0057316 A1
(43) Pub. Date: Mar. 16, 2006

(54) Roll-like product of heat-shrinkable film, process for producing the same, and process for controlling the same

(76) Inventors: Takashi Namba, Greensboro, NC (US); Takashi Fujii, Kakogawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/134,614

(22) Filed: May 20, 2005

(30) Foreign Application Priority Data
May 24, 2004 (JP) 2004-152993

(51) Int. Cl. B32B 1/08

(52) U.S. Cl. 428/34.3; 428/34.9

(57) ABSTRACT

According to the process for producing a heat-shrinkable film of the present invention, a roll-like product 10 of a heat-shrinkable film is produced by winding a heat-shrinkable film 12 while maintaining the controlled water content of a paper-pipe core 11 at not more than 8.5% around the paper-pipe core 11 which has a coefficient of friction μ on the surface of the paper-pipe core 11 of not less than 0.3, and the water content (A) of not more than 8.0% after it is dried at 105° C. for 20 hours and then allowed to stand in an environment of 20° C. and a relative humidity of 65% for 168 hours.

### BACKGROUND OF THE INVENTION

1. Field of the Invention

The present invention relates to a roll-like product of a heat-shrinkable film, a process for producing the same, and a process for controlling the same.

Priority is claimed on Japanese Patent Application No. 2004-152993, filed May 24, 2004, the content of which is incorporated herein by reference.

2. Description of the Related Art

In production of a roll-like film product, there is a problem in that a rolled film deforms like an extensible telescope (referred to as “winding deformation” hereinafter) and that a paper core pipe slips out from the roll-like film product (referred to as “paper-pipe core displacement” hereinafter), due to the environmental difference between the factory where the roll-like film product is produced and the place where the roll-like product is stored, conveyed, or used.

In particular, as for a roll-like product of a heat-shrinkable film, the winding deformation and the paper-pipe core displacement are likely to occur because of the following reasons. That is, a heat-shrinkable film shrinks by several percent even in an environment of not higher than 40° C. (i.e. as spontaneous shrinkage), although a heat-shrinkable film generally shrinks largely at a temperature ranging from 60 to 100° C. Therefore, it is necessary to wind the heat-shrinkable film around a paper-pipe core with a tension which is inferior to a tension for films with no spontaneous shrinkage, so that the winding deformation and the paper-pipe core displacement easily occur due to environmental changes because the tension upon winding the film around the paper-pipe core is low.

In general, a roll-like film product becomes more susceptible to the winding deformation and the paper-pipe core displacement, when an environmental temperature or humidity decreases. Therefore, in winter when the environmental temperature and humidity decrease, the film is wound around a paper-pipe core with a higher tension than that used in summer. However, if the film is wound around a core with a high tension, then a problem of creasing and the like may occur. Therefore, hitherto various countermeasures have been adopted such as controlling the tension upon winding, controlling the tension so as to wind a film at a constant torque, adjusting the tension while detecting the diameter of the rolled film, or the like. However, with any of these countermeasures, it has been difficult to produce a roll-like film product in which the occurrence of the winding deformation, and the paper-pipe core displacement can be prevented without causing any creasing.

Each of Patent document 1 (Japanese Unexamined Patent Application, First Publication No.2002-114418) and Patent document 2 (Japanese Unexamined Patent Application, First Publication No.2003-40495) discloses a method for preventing the winding deformation by applying a rubber layer to a part or the entirety of the paper-core pipe so as to increase the adherence with web. However, if a rubber layer is applied, then it becomes difficult to control the smoothness of the surface of the rubber layer. When there are defects in the smoothness, the web of rolled film is likely to deform. Moreover, in the case in which a rubber layer is applied to a part of the paper core pipe, the web is likely to deform, because the coefficient of friction differs between the portion where the rubber layer is applied and the portion where the rubber is not applied, such that an uneven tension is applied to the web.

### SUMMARY OF THE INVENTION

Accordingly, it is an object of the present invention to provide a roll-like product in which the winding deformation and paper-pipe core displacement can be prevented, a process for producing such a roll-like product, and a process for controlling such a roll-like product.

The inventors of the present invention have researched throughly the state of the generated winding deformation and the paper-pipe core displacement and have found unexpectedly that the property of the paper core pipe is related closely with the generation of the winding deformation and the paper-pipe core displacement rather than the tension applied to the film upon being rolled, thereby completing the present invention.

That is, the roll-like product of a heat-shrinkable film according to the present invention includes a paper-pipe core, and a heat-shrinkable film wound around the paper-pipe core, wherein the coefficient of friction μ on the surface of the paper-pipe core is not less than 0.3, and the water content calculated from the following formula (1) is not more than 8.5%:
water content (%)=(mᵤ−m_{d})×100/m_{d} (1)
(in formula (1), mᵤ represents the mass (g) of the paper-pipe core, and m_{d} represents the mass (g) of the paper-pipe core after being dried at 105° C. for 20 hours).

The process for producing a roll-like product of a heat-shrinkable film according to the present invention includes: winding a heat-shrinkable film while maintaining the water content calculated from the following formula (1) at not more than 8.5% around a paper-pipe core of which the coefficient of friction μ on the surface of the paper-pipe core is not less than 0.3, and the water content (A) calculated from the following formula (2) is not more than 8.0%:
water content (A) (%)=(mᵢ−m_{d})×100/m_{d} (2)
(in formula (2), mᵢ represents the mass (g) of the paper-pipe core after being dried at 105° C. for 20 hours and thereafter being allowed to stand in an environment of a temperature of 20° C. and a relative humidity of 65% for 168 hours, and m_{d} represents the mass(g) of the paper-pipe core after being dried at 105° C. for 20 hours),
water content (%)=(mᵤ−m_{d})×100/m_{d} (1)
(in formula (1), mᵤ represents the mass (g) of the paper-pipe core, and m_{d} represents the mass (g) of the paper-pipe core after being dried at 105° C. for 20 hours).

In the process for producing a roll-like product of a heat-shrinkable film according to the present invention, it is preferred that the heat-shrinkable film be wound around the paper-pipe core with a tension of not less than 50 N/m and less than 60% of a yield point stress of the heat-shrinkable film.

The process for controlling the roll-like product of a heat shrinkable film according to the present invention includes: maintaining the water content of the paper-pipe core calculated from the following formula (1) at not more than 8.5%:
water content (%)=(mᵤ−m_{d})×100/m_{d} (1)
(in formula (1), mᵤ represents the mass (g) of the paper-pipe core, and m_{d} represents the mass (g) of the paper-pipe core after being dried at 105° C. for 20 hours), with respect to the roll-like product of a heat-shrinkable film produced by the process according to the present invention.

The roll-like product of a heat-shrinkable film of the present invention is one which can prevent the winding deformation and the paper-pipe core displacement.

According to the process for producing a roll-like product of a heat-shrinkable film of the present invention, it is possible to produce the roll-like product of a heat-shrinkable film which can prevent the winding deformation and the paper-pipe core displacement.

According to the process for controlling a roll-like product of a heat-shrinkable film of the present invention, it is possible to prevent the winding deformation and the paper-pipe core displacement of the roll-like product of a heat-shrinkable film.

### BRIEF DESCRIPTION OF THE DRAWINGS

FIG. 1 is a perspective view showing an example of the roll-like product of a heat-shrinkable film of the present invention.

FIG. 2 is a schematic view showing the measuring method of the friction coefficient μ on the surface of the paper-pipe core, the left side is the end face of the paper-pipe core, and the right side is the side view.

FIG. 3 is a schematic block diagram showing an example of the apparatus used for producing the roll-like product of a heat-shrinkable film of the present invention.

### DETAILED DESCRIPTION OF THE INVENTION

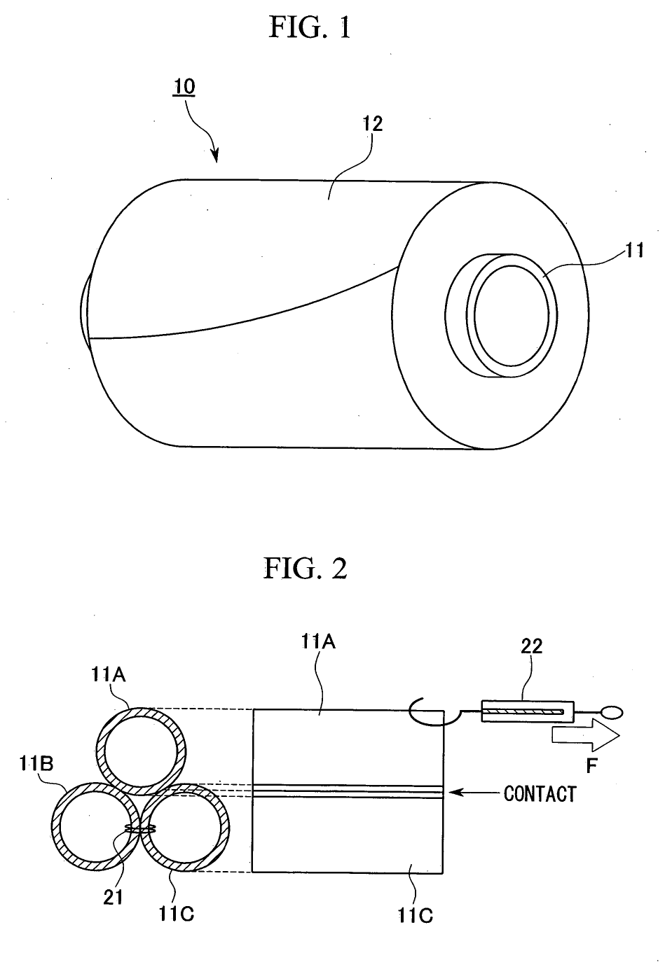

FIG. 1 is a perspective view showing an example of a roll-like product 10 of a heat-shrinkable film of the present invention. This roll-like product 10 of a heat-shrinkable film consists of a paper-pipe core 11 and a long heat-shrinkable film 12 which is wound around the paper-pipe core 11.

The paper-pipe core 11 is a paper pipe which has a coefficient of friction μ on the surface thereof of not less than 0.3, and a water content which is calculated from the above formula (1) of not more than 8.5%. Winding deformation and paper-pipe core displacement can be prevented by using the paper-pipe core 11 as such. The coefficient of friction on the surface of the paper-pipe core is preferably from 0.3 to 0.6. If the coefficient of friction μ becomes more than 0.6, then the paper-pipe cores become adhesive to each other, thereby deteriorating the workability. The water content of the paper-pipe core which is calculated from the above formula (1) is preferably within the range from 5.0 to 8.5%. If the water content is less than 5.0%, then the strength of the paper-pipe core becomes insufficient, thereby making the paper on the surface of the paper-pipe core easily strippable.

The coefficient of friction μ on the surface of the paper-pipe core is measured by the following method.

Three pieces of a paper-pipe core of the same type are prepared, having a length of 1000 mm, an inner diameter of 76.2 mm, a thickness of 12 mm, and a mass in g and these paper-pipe cores are, as shown in FIG. 2, fixed with a wire 21 such that two paper-pipe cores 11B and 11C are closely adhered to each other. The fixed two paper-pipe cores 11B and 11C are set on a horizontal base, and then the remaining paper-pipe core 11A is set thereon as shown in FIG. 2, and thereafter a through-hole is perforated at a top end of the paper-pipe core 11A, to which a hook of a spring balance 22 is attached and a paper-pipe core 11A is pulled horizontally in a longitudinal direction of the paper-pipe core. The maximum pulling force (tension) F(g) when the paper-pipe core 11A starts to slide from the paper-pipe cores 11B and 11C is read on the printed scale of the spring balance to calculate the coefficient of friction μ from the following formula (3):

$$μ = \frac{\sqrt{3}}{2} \times \frac{F}{m} \qquad ( 3 )$$

General resins may be employed as the resin for use in the heat-shrinkable film 12. For example, polyolefin type resin, polyvinyl chloride resin, polystyrene type resin, polyester type resin, polyamide type resin, etc. are exemplary.

As the polyolefin type resin, for example, polyethylene type resins such as a high-pressure method low density polyethylene, copolymer of ethylene and α-olefin having 4 to 8 carbon atoms, linear-low density polyethylene (L-LDPE), ethylene-vinyl acetate copolymer, etc.; polypropylene type resins such as polypropylene monopolymer, ethylene-propylene random copolymer, ethylene-butene-propylene copolymer, butane-propylene random copolymer, etc.; monopolymer of cyclic olefin, random copolymer of α-olefin having 2 to 20 carbon atoms and cyclic olefin; and graft denaturated products thereof are exemplary.

As the polyvinyl chloride, for example, a polyvinyl chloride having a number average degree of polymerization of approximately 800 to 2500, preferably of approximately 1000 to 1800; copolymers mainly consisting of vinyl chloride such as ethylene-vinyl chloride copolymer, vinyl acetate-vinyl chloride copolymer, vinyl chloride-halogenated olefin copolymer, etc.; blended products of polyvinyl chloride or vinyl chloride copolymer and another compatible resin (for example polyester resin, epoxy resin, acryl resin, vinyl acetate resin, urethane resin, acrylonitrile-styrene-butadiene copolymer, and partially saponificated polyvinyl alcohol, etc. ), which mainly consist of these polyvinyl chlorides or vinyl chloride copolymers, etc. are exemplary. As the polyvinyl chloride resin, those produced by any methods commonly used such as a bulk polymerizing method, an emulsion polymerizing method, a suspension polymerizing method, a solution polymerizing method, etc., may be employable.

As the polystyrene type resin, for example, styrene-butadiene-styrene type block copolymer, styrene-butyl (meth)acrylate type copolymer, transparent and impact-resistant polystyrene, GP polystyrene, styrene-butadiene type thermoplastic elastomer, etc. are exemplary. One sort of these may be employed solely, or two or more sorts of these may be employed in combination. Among these, one which is mainly consists of styrene-butadiene-styrene type block copolymer is preferred.

As the polyester type resin, for example, polyester type resin which is obtained by performing condensation polymerization of a dicarboxylic acid component and diol component is exemplary. As the dicarboxylic acid component, aromatic dicarboxylic acids such as terephthalic acid, isophthalic acid, phthalic acid, naphthalene dicarboxylic acid, etc.; aliphatic dicarboxylic acids such as adipic acid, sebacic acid, cyclohexane dicarboxylic acid, etc., are exemplary. Among these, terephalic acid is especially preferable. As the diol component, ethylene glycol, 1,4-cyclohexanedimethanol, diethylene glycol, neopentyl glycol, 1,4-butanediol, 1,6-hexanediol, etc. are exemplary. Among these, ethylene glycol is especially preferable.

Specifically, as the polyester type resin obtained by performing condensation polymerization of a dicarboxylic acid component and diol component, commonly used polyesters such as a polyethylene terephthalate in which 1,4-cyclohexanedimethanol of 10 to 40 mol % is copolymerized; polyethylene terephthalate in which isophthathalic acid of 0 mol % to 25 mol % is copolymerized, etc. are exemplary.

As other polyester type resins, polyesters obtained by performing condensation polymerization or ring-opening polymerization of hydroxycarboxylic acids such as lactic acid, hydroxybutyric acid, polycaprolactone, etc., are exemplary. One sort of these polyester type resins may be employed solely, and two or more may be employed in combination.

As the polyamide type resin, for example, those obtained by performing ring-opening polymerization of cyclic aliphatic lactam such as 6-nylon, 12-nylon, etc.; those obtained by condensation polymerization of aliphatic diamine and aliphatic dicarboxylic acid such as 6,6-nylon, 6,10-nylon, 6,12-nylon etc.; those obtained by condensation polymerization of an aromatic diamine and aliphatic dicarboxylic acid such as one obtained by performing condensation polymerization of m-xylenediamine and adipic acid; those obtained by performing condensation polymerization of an aromatic diamine and aromatic dicarboxylic acid such as a condensation-polymerization product of p-phenylenediamine and terephthalic acid, condensation-polymerization product of m-phenylenediamine and isophthalic acid, etc.; a condensation-polymerization product of an amino acid such as 1 1-nylon, are exemplary.

The resin may be a monopolymer or may be a copolymer.

The resin may contain additives, such as an ultraviolet absorbing agent, an anti-blocking agent, grease, an antistatic agent, a flame retardant, a coloring agent, a lubricant, a plasticizer, a filler, and a shock-proof improvement agent, if it is required.

The heat-shrinkable film 12 may also have a multilayer structure, in order to improve the physical properties, chemical nature, etc. The heat-shrinkable film with the multilayer structure may also have one or more of a foaming layer.

The heat-shrinkable film 12 may also be covered with acrylic resin, urethane resin, polyamide, polyolefin, polyvinyl alcohol, polyvinylidene chloride, polyester, etc. The heat-shrinkable film 12 may also have a metal thin film formed by metal vapor deposition. The heat-shrinkable film 12 may have been subjected to surface treatment such as corona treatment, plasma treatment, flame treatment, etc.; radiation processing using, for example, ultraviolet rays, α-rays, β-rays, γ-rays, electron beam, etc., in order to impart specific characteristics.

Next, the process for producing the roll-like product of a heat-shrinkable film 12 will be explained.

The roll-like product of a heat-shrinkable film 12 is produced by the step of producing a heat-shrinkable film 12, and the step of winding the heat-shrinkable film around a paper-pipe core.

The heat-shrinkable film 12 is produced by well-known extruding technology and extending technology. For example, a melted resin is extruded from a T die of an extruding apparatus into a flat sheet, and the resultant flat sheet is cooled down, and thereafter the flat sheet is subjected to tenter drawing so as to be drawn by 3 to 10 times in cross direction, and then the flat sheet is annealed while relaxing the drawing force by 0 to 12% in a width direction if required, to obtain a heat-shrinkable film 12.

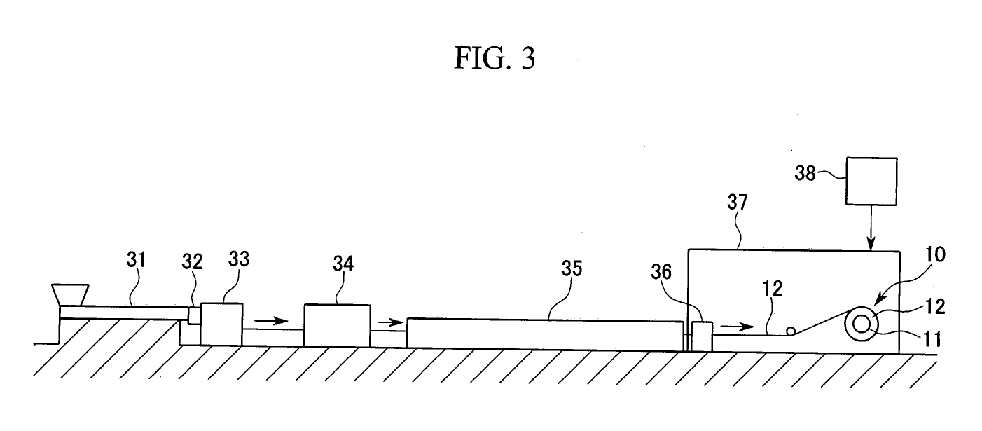

Moreover, the heat-shrinkable film 12 is also obtained by extruding a melted resin from a T die 32 of an extruding apparatus 31 into a flat sheet, as shown in FIG. 3, cooling the resultant flat sheet by a cooling apparatus 33, and then drawing the flat sheet in a longitudinal direction with a longitudinally drawing apparatus 34, and thereafter drawing the flat sheet in a lateral direction with a laterally drawing apparatus 35.

Moreover, the drawing operation may be performed according to the well-known simultaneous 2 axes extending method. Moreover, it is also possible to extrude a tubular sheet from a round die, and then draw the resultant tubular sheet, alternatively, the resultant tubular sheet may be cut and opened to a flat sheet, and the resultant flat sheet may be drawn.

The thus obtained heat-shrinkable film 12 is, as shown in FIG. 3, cooled down at a cooling part 36 of the laterally drawing apparatus 35, and then the heat-shrinkable film 12 is rolled around the paper-pipe core 11 by a drawing and rolling apparatus (not shown in the drawing) to obtain the roll-like product 10 consisting of the paper-pipe core 11 and the heat-shrinkable film 12 wound around the paper-pipe core 11.

As the paper-pipe core 11 which is used when winding the heat-shrinkable film 12 thereon, a paper pipe having a coefficient of friction μ on the surface thereof not less than 0.3, and a water content (A) calculated from the above formula (2) not more than 0.8 is employed. The winding deformation and the paper-pipe-core displacement can be suppressed by employing such a paper-pipe core 11. The coefficient of friction μ on the surface of the paper-pipe core 11 preferably ranges from 0.3 to 0.6. If the coefficient of friction μ exceeds 0.6, then the paper-pipe core 11 becomes adhesive to each other, thereby deteriorating the workability. The water content (A) preferably ranges from 5.0 to 8.0%. If the water content (A) is less than 5.0%, then the mechanical strength of the paper-pipe core 11 becomes insufficient, thereby making the paper on the surface easily strippable.

When winding the heat-shrinkable film 12 around the paper-pipe core 11 the heat-shrinkable film 12 is wound around the paper-pipe core 11, while maintaining the water content (referred to as “controlled water content” hereinafter) of the paper-pipe core 11 calculated from the above formula (1) at not more than 8.5%. The winding deformation and the paper-pipe core displacement can be suppressed by maintaining the controlled water content of the paper-pipe core 11 at not more than 8.5%. The controlled water content of the paper-pipe core preferably ranges from 5.0 to 8.5%. If the controlled water content is less than 5.0%, then the mechanical strength of the paper-pipe core becomes insufficient, thereby making the paper on the surface easily strippable.

Maintaining the controlled water content of the paper-pipe core 11 calculated from the above formula (1) at not more than 8.5% can be achieved by, for example, supplying air of which temperature and humidity are adjusted from the air-conditioner 38 into a control room 37 where the drawing and winding apparatus is equipped, to control the environment within the control room 37 such that the controlled water content of the paper-pipe core 11 should always be not more than8.5%.

The tension of the heat-shrinkable film 12 when winding the film around the paper-pipe core is preferably not less than 50 N/m and less than 60% of the yield point stress of the heat-shrinkable film 12. The winding deformation and the paper-pipe core displacement can be further suppressed by setting the tension of the heat-shrinkable film 12 upon being wound to not less than 50 N/m. Creasing and the like can be suppressed by setting the tension of the heat-shrinkable film 12 upon being wound to be less than 60% of the yield point stress of the heat-shrinkable film 12.

The roll-like product 10 of the heat-shrinkable film 12 thus obtained is preferably controlled such that the water content of the paper-pipe core 11 calculated from the above formula (1) is maintained at not more than 8.5% when it is stored, conveyed, and used. The controlled water content of the paper-pipe core preferably ranges from 5.0 to 8.5%. If the controlled water content is less than 5.0%, then the mechanical strength of the paper-pipe core becomes insufficient, thereby making the paper on the surface of the paper-pipe core easily strippable.

According to the present invention, the winding deformation and the paper-pipe core displacement in the roll-like product of a heat-shrinkable film 12 can be suppressed. Thereby, it becomes unnecessary to dispose the rubber layer for preventing the winding deformation, etc., in the paper-pipe core 11, and hence deformation and breakage of the heat-shrinkable film 12 can be suppressed. And problems generated when the heat-shrinkable film 12 is used, such as when printing and performing heat-shrinking, etc., can be avoided by suppressing the deformation and the breakage of the heat-shrinkable film 12.

Moreover, according to the present invention, the winding deformation and the paper-pipe core displacement hardly occur, even if the tension of the heat-shrinkable film 12 upon being wound becomes lower than the tension of a conventional process, because the heat-shrinkable film 12 is wound around the paper-pipe core 11, while maintaining the controlled water content of the paper-pipe core 11 at not more than 8.5% using the paper-pipe core 11 which hardly causes the winding deformation and the paper-pipe displacement. Specifically, the tension upon being wound can be less than 60% of the yield point stress of the heat-shrinkable film 12.

Hereafter, embodiments of the present invention will be explained. The present invention is not limited at all by the embodiments.

Methods for measuring each of the physical properties in the embodiments are as follows.

(Measurement of Coefficient of Friction)

Three paper-pipe cores (mass m=2,600g) having a length of 1000 mm, an inner diameter of 76.2 mm, and thickness of 12 mm of the same kind were prepared and, as shown in FIG. 2, two paper-pipe cores 11B and 11C were fixed with the wiring 21 so that the paper-pipe cores 11B and 11C were in close contact with each other. These two paper-pipe cores 11B and 11C thus fixed were placed on a horizontal base, and, as shown in FIG. 2, the remaining paper-pipe core 11A was placed thereon, a hole was perforated at the top end of the paper-pipe core 11A, and then a hook of the spring balance 22 was attached thereon, and pulled horizontally along a longitudinal direction of the paper-pipe core. The maximum drawing force (tension) F (N) by which the paper-pipe core 11A started to slide from the paper-pipe cores 11B and 11C was read on the scale of the spring balance to calculate the coefficient of friction μ from the above formula (3).

(Measurement of the Water Content (A))

A paper-pipe core having a length of 90 mm, an inner diameter of 76.2 mm, and a thickness of 12 mm was put in a hot air dryer held at a temperature of 105° C. and a relative humidity not more than 10% and allowed to stand for 20 hours, and thereafter the mass of the paper-pipe core m_{d} was recorded. Subsequently, the paper-pipe core was put in a thermo-hygrostat held at a temperature of 20° C. and a relative humidity 65% and allowed to stand for 168 hours, and thereafter the mass of the paper-pipe core mᵢ was recorded, and the water content of the paper-pipe core was calculated from the above formula (2).

(Measurement of the Controlled Water Content)

Five paper-pipe cores each of which had a length of 960 mm, an inner diameter of 76.2 mm, and a thickness of 12 mm were sampled, and each of the mass t was recorded. Subsequently, the paper-pipe cores were put in a hot air dryer held at a temperature of 105° C. and a relative humidity not more than 10% and allowed to stand for 20 hours, and thereafter the mass of the paper-pipe cores m_{d} was recorded, and the controlled water content of the paper-pipe cores was calculated from the above formula (1), and then the mean value of the five paper-pipe cores was considered as the controlled water content of the paper-pipe core which was used in the production of the roll-like product.

(Winding Tension)

The winding tension was adjusted by a rewinding apparatus Model 513E so as to be a predetermined value, when winding a heat-shrinkable film with a width of 960 mm by 3000 m around a paper-pipe core using the rewinding apparatus 513E made by GODOKIKO, Co., Ltd.

(Winding Deformation Test)

A roll-like product of a heat-shrinkable film was placed in a state of standing vertically in an environmental test room held at a temperature of 8° C., and a relative humidity of 50%, and allowed to stand there for 3 days. Subsequently, the roll-like product taken out from the environmental test room was hung up using MY-E254S made by MOTODA DENSHI KOUGYO Co., Ltd., and it was observed whether the winding deformation and the paper-pipe core displacement might occur or not at that time, and the samples which exhibited no occurrence of the winding deformation and the paper-pipe core displacement were evaluated as “O”, which means “excellent”.

The coefficient of friction and the water content (A) of the paper-pipe cores which were used in this embodiment are shown in Table 1.

TABLE 1

| | Paper-pipe core | | | |
|---|---|---|---|---|
| | | | Comparison | Comparison |
| | Paper-pipe | Paper-pipe | paper-pipe | paper-pipe |
| | core 1 | core 2 | core 1 | core 2 |
| Coefficient of | 0.40 | 0.40 | 0.16 | 0.20 |
| Friction μ | | | | |
| Water Content (A) | 6.5 | 7.4 | 6.5 | 8.5 |
| (%) | | | | |

### EXAMPLE 1 AND 2 AND COMPARATIVE EXAMPLES 1 to 3

(a) 70 mass parts of polyethylene terephthalate copolymer in which 30 mol % of cyclohexanedimethanol was copolymerized, and (b) 30 mass parts of polyethylene terephthalate copolymer in which 5 mol % of isophthalic acid and 1.5 mol % of diethylene glycol were copolymerized, were blended. The mixture (T_{g}=79° C.) was supplied to a two-axial extruding apparatus, thereby melting the mixture at 280° C., extruding the mixture from a T die, while dewatering it from the vent holes, and casting it at 25° C. to obtain a sheet having a thickness of 160 to 530 μm. This sheet was conveyed to a roll type drawing apparatus, thereby drawing the sheet by 3.8 times in a longitudinal direction, and cooling the sheet immediately to 70° C., and then drawing the sheet by 1.5 times in a lateral direction at 89° C. by tenter, and thereafter fixing the temperature thereof at 85° C. to obtain a heat-shrinkable film having a thickness of 35 μm.

Thereafter, three of the roll-like products consisting of the paper-pipe core having a length of 960 mm, an inner diameter of 76.2 mm, and a thickness of 12 mm, as shown in Table 1, and a 3000-m film wound around the paper-pipe core were produced for each of paper-pipe cores of Examples and Comparative Examples, respectively, while maintaining a predetermined winding tension using the rewinding apparatus 513E made by GODOKIKO, Co., Ltd. At that time, the atmospheric temperature around the rewinding apparatus was 18 to 22° C. And the relative humidity around the rewinding apparatus was 20 to 50% RH.

The controlled water content, the winding tension, and the winding deformation test results of each Example and Comparative Example are shown in Table 2. Moreover, when the paper-pipe core was extracted from the roll-like product of the obtained heat-shrinkable film and the controlled water content was measured for this paper-pipe core, it turned out that no change was observed in each Example and Comparative Example in the controlled water content before and after production.

TABLE 2

| | | | Comparative | Comparative | Comparative |
|---|---|---|---|---|---|
| | Example 1 | Example 2 | Example 1 | Example 2 | Example 3 |
| Paper-pipe core | Paper-pipe | Paper-pipe | Comparison | Comparison | Comparison |
| | core 1 | core 2 | paper-pipe core | paper-pipe core | paper-pipe core |
| | | | 1 | 1 | 2 |
| Controlled Water | 7.2 | 8.3 | 8.9 | 7.2 | 8.3 |
| Content (%) | | | | | |
| Winding tension (N) | 72 | 85 | 85 | 45 | 85 |
| Winding | O | O | Paper-pipe core | Winding | Paper-pipe core |
| Deformation test | | | displacement | Deformation | displacement |
| result | | | | | |

As mentioned above, although the preferred embodiments of the present invention were explained, the present invention is not limited to these embodiments. As long as the spirit and scope of the present invention are not departed from, addition, omission, substitution of constitution, and other modifications are possible. The present invention is not limited by the explanation above, and is limited by the attached claims.

The roll-like product of the heat-shrinkable film of the present invention is used for the heat-shrinkable labels or heat-shrinkable packing used for PET bottles etc.

What is claimed is:

1. A roll-like product comprising a paper-pipe core, and a heat-shrinkable film wound around the paper-pipe core, wherein a coefficient of friction μ on the surface of the paper-pipe core is not less than 0.3, and the water content calculated from the following formula (1) is not more than 8.5%:
water content (%)=(mᵤ−m_{d})×100/m_{d} (1)
(in formula (1), mᵤ represents mass (g) of the paper-pipe core, and m_{d} represents mass (g) of the paper-pipe core after being dried at 105° C. for 20 hours).

2. A process for producing a roll-like product, comprising:
winding a heat-shrinkable film while maintaining water content calculated from the following formula (1) at not more than 8.5% around a paper-pipe core of which coefficient of friction μ between the surface of the paper-pipe core is not less than 0.3, and water content (A) calculated from the following formula (2) is not more than 8.0%:
water content (A) (%)=(mᵢ−m_{d})×100/m_{d} (2)
(in formula (2), mᵢ represents mass (g) of the paper-pipe core after being dried at 105° C. for 20 hours and thereafter being allowed to stand in an environment of a temperature of 20° C. and a relative humidity of 65% for 168 hours, and m_{d} represents mass (g) of the paper-pipe core after being dried at 105° C. for 20 hours),
water content (%)=(mᵤ−m_{d})×100/m_{d} (1)
(in formula (1), mᵤ represents mass (g) of the paper-pipe core, and m_{d} represents mass (g) of the paper-pipe core after being dried at 105° C. for 20 hours).

3. The process for producing a roll-like product as set forth in claim 2, wherein the heat-shrinkable film is wound around the paper-pipe core with a tension of not less than 50 N/m and less than 60% of yield point stress of the heat-shrinkable film.

4. A process for controlling the roll-like product of a heat shrinkable film produced by the process as set forth in claim 2, comprising:
maintaining the water content of the paper-pipe core calculated from the following formula (1) at not more than 8.5%:
water content (%)=(mᵤ−m_{d})×100/m_{d} (1)
(in formula (1), mᵤ represents mass (g) of the paper-pipe core, and m_{d} represents mass (g) of the paper-pipe core after being dried at 105° C. for 20 hours).
